(19) United States
(12) Patent Application Publication
(10) Pub. No.: US 2023/0297168 A1
(43) Pub. Date: Sep. 21, 2023

(54) Changing a Dimensional Representation of a Content Item

(71) Applicant: Apple Inc., Cupertino, CA (US)

(72) Inventors: Nicolai Georg, San Francisco, CA (US); Aaron M. Burns, Sunnyvale, CA (US); Adam G. Poulos, Saratoga, CA (US); Arun Rakesh Yoganandan, San Francisco, CA (US); Benjamin Hylak, San Francisco, CA (US); Benjamin R. Blachnitzky, San Francisco, CA (US)

(21) Appl. No.: 18/121,993

(22) Filed: Mar. 15, 2023

Related U.S. Application Data
(63) Continuation of application No. PCT/US21/49096, filed on Sep. 3, 2021.
(60) Provisional application No. 63/079,015, filed on Sep. 16, 2020.

(51) Int. Cl. G06F 3/01; G06F 3/04842; G06F 3/04815; G06F 3/0346

(52) U.S. Cl. CPC G06F 3/014; G06F 3/017; G06F 3/04842; G06F 3/04815; G06F 3/0346

(57) ABSTRACT

A method is performed at an electronic device with one or more processors, a non-transitory memory, a display, and a communication interface provided to communicate with a finger-wearable device. The method includes, while displaying a plurality of content items on the display, obtaining finger manipulation data from the finger-wearable device via the communication interface. The method includes selecting a first one of the plurality of content items based on a first portion of the finger manipulation data in combination with satisfaction of a proximity threshold. The first one of the plurality of content items is associated with a first dimensional representation. The method includes changing the first one of the plurality of content items from the first dimensional representation to a second dimensional representation based on a second portion of the finger manipulation data.

### CROSS-REFERENCE TO RELATED APPLICATIONS

This application is a continuation of Intl. Patent App. No. PCT/US2021/049096, filed on Sep. 3, 2021, which claims priority to U.S. Provisional Patent App. No. 63/079,015, filed on Sep. 16, 2020, which are hereby incorporated by reference in their entirety.

### TECHNICAL FIELD

The present disclosure relates to displaying a content item, and in particular, modifying an appearance of the content item.

### BACKGROUND

An electronic device may enable manipulation of a displayed content item based on an input from an integrated input system, such as an extremity tracking input or an eye tracking input. Utilizing an input from an integrated input system in order to manipulate a content item introduces a number of issues. For example, when a physical object occludes a portion of an extremity of a user, the reliability of the extremity tracking input is correspondingly reduced. As another example, a content item that has a relatively high depth with respect to the display, such as a content item located in a scene background, may be difficult for a user to manipulate, thereby introducing tracking inaccuracies.

### SUMMARY

In accordance with some implementations, a method is performed at an electronic device with one or more processors, a non-transitory memory, a display, and a communication interface provided to communicate with a finger-wearable device. The method includes, while displaying a plurality of content items on the display, obtaining finger manipulation data from the finger-wearable device via the communication interface. The method includes selecting a first one of the plurality of content items based on a first portion of the finger manipulation data in combination with satisfaction of a proximity threshold. The first one of the plurality of content items is associated with a first dimensional representation. The method includes changing the first one of the plurality of content items from the first dimensional representation to a second dimensional representation based on a second portion of the finger manipulation data.

In accordance with some implementations, an electronic device includes one or more processors, a non-transitory memory, a display, and a communication interface provided to communicate with a finger-wearable device. One or more programs are stored in the non-transitory memory and are configured to be executed by the one or more processors. The one or more programs include instructions for performing or causing performance of the operations of any of the methods described herein. In accordance with some implementations, a non-transitory computer readable storage medium has stored therein instructions which when executed by one or more processors of an electronic device, cause the device to perform or cause performance of the operations of any of the methods described herein. In accordance with some implementations, an electronic device includes means for performing or causing performance of the operations of any of the methods described herein. In accordance with some implementations, an information processing apparatus, for use in an electronic device, includes means for performing or causing performance of the operations of any of the methods described herein.

### BRIEF DESCRIPTION OF THE DRAWINGS

For a better understanding of the various described implementations, reference should be made to the Description, below, in conjunction with the following drawings in which like reference numerals refer to corresponding parts throughout the figures.

FIG. 1 is a block diagram of an example of a portable multifunction device in accordance with some implementations.

FIG. 2 is a block diagram of an example of a finger-wearable device in accordance with some implementations.

FIGS. 3A-3S are examples of an electronic device changing dimensional representations of respective content items in accordance with some implementations.

FIG. 4 is an example of a flow diagram of a method of changing a dimensional representation of a content item in accordance with some implementations.

### DESCRIPTION OF IMPLEMENTATIONS

An electronic device, including an integrated input system, may manipulate the display of a content item based on an input from the integrated input system. For example, the integrated input system includes an extremity tracking input system or an eye tracking input system. As one example, based on an extremity tracking input, the electronic device determines a corresponding extremity of a user that satisfies a proximity threshold with respect to a particular content item. Accordingly, the electronic device manipulates the particular content item based on the extremity tracking input. However, utilizing an input from an integrated input system in order to manipulate a content item. For example, when a physical object occludes (e.g., blocks) a portion of a user's extremity, the reliability of the extremity tracking input is correspondingly reduced. As another example, the limited mobility of a user's eyes and the unsteadiness of the user's extremity reduces the efficiency associated with manipulating a content item. As yet another example, a content item that has a relatively high depth with respect to the display, such as a content item located in a scene background, may be difficult for a user to manipulate, thereby introducing extremity tracking and eye tracking inaccuracies.

By contrast, various implementations disclosed herein include methods, electronic devices, and systems for selecting a particular content item and changing a dimensional representation of the particular content item based on finger manipulation data from a finger-wearable device. To that end, an electronic device includes a display for displaying a plurality of content items, and includes a communication interface provided to communicate with the finger-wearable device. While displaying the plurality of content items, the electronic device obtains the finger manipulation data via the communication interface. The electronic device selects a first one of the plurality of content items based on a first portion of the finger manipulation data in combination with satisfaction of a proximity threshold. For example, the first portion of the finger manipulation data is indicative of a pinch gesture, and the pinch gesture is associated with a respective position on the display that is less than a threshold distance from the first one of the plurality of content items. The first one of the plurality of content items is associated with a first dimensional representation, such as a two-dimensional (2D) representation or a three-dimensional (3D) representation. Based on a second portion of the finger manipulation data, the electronic device changes the first one of the plurality of content items from the first dimensional representation to a second dimensional representation. The change to the dimensional representation may be bidirectional. For example, a pull gesture (e.g., pulling a content item out of a grid) directed to the first one of the plurality of content items results in a 2D-to-3D representation conversion. As another example, a push gesture (e.g., pushing a content item into a grid) directed to the first one of the plurality of content items results in a 3D-to-2D representation conversion. Accordingly, various implementations disclosed herein enable a user wearing the finger-wearable device to effectively engage with (e.g., manipulate) content items.

In some implementations, the electronic device tracks a finger of a user wearing a finger-wearable device with six degrees of freedom (6DOF) based on finger manipulation data, such as 3D positional data and 3D rotational data from respective sensors integrated in the finger-wearable device. Accordingly, even when a physical object occludes a portion of the finger-wearable device on the display, the electronic device continues to receive finger manipulation data from the finger-wearable device. On the other hand, other devices that utilize extremity tracking alone cannot track an extremity of a user when a physical object occludes the extremity.

### DESCRIPTION

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described implementations. The first contact and the second contact are both contacts, but they are not the same contact, unless the context clearly indicates otherwise.

The terminology used in the description of the various described implementations herein is for the purpose of describing particular implementations only and is not intended to be limiting. As used in the description of the various described implementations and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes”, “including”, “comprises”, and/or “comprising”, when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting”, depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]”, depending on the context.

A person can interact with and/or sense a physical environment or physical world without the aid of an electronic device. A physical environment can include physical features, such as a physical object or surface. An example of a physical environment is physical forest that includes physical plants and animals. A person can directly sense and/or interact with a physical environment through various means, such as hearing, sight, taste, touch, and smell. In contrast, a person can use an electronic device to interact with and/or sense an extended reality (XR) environment that is wholly or partially simulated. The XR environment can include mixed reality (MR) content, augmented reality (AR) content, virtual reality (VR) content, and/or the like. With an XR system, some of a person's physical motions, or representations thereof, can be tracked and, in response, characteristics of virtual objects simulated in the XR environment can be adjusted in a manner that complies with at least one law of physics. For instance, the XR system can detect the movement of a user's head and adjust graphical content and auditory content presented to the user similar to how such views and sounds would change in a physical environment. In another example, the XR system can detect movement of an electronic device that presents the XR environment (e.g., a mobile phone, tablet, laptop, or the like) and adjust graphical content and auditory content presented to the user similar to how such views and sounds would change in a physical environment. In some situations, the XR system can adjust characteristic(s) of graphical content in response to other inputs, such as a representation of a physical motion (e.g., a vocal command).

Many different types of electronic systems can enable a user to interact with and/or sense an XR environment. A non-exclusive list of examples include heads-up displays (HUDs), head mountable systems, projection-based systems, windows or vehicle windshields having integrated display capability, displays formed as lenses to be placed on users' eyes (e.g., contact lenses), headphones/earphones, input systems with or without haptic feedback (e.g., wearable or handheld controllers), speaker arrays, smartphones, tablets, and desktop/laptop computers. A head mountable system can have one or more speaker(s) and an opaque display. Other head mountable systems can be configured to accept an opaque external display (e.g., a smartphone). The head mountable system can include one or more image sensors to capture images/video of the physical environment and/or one or more microphones to capture audio of the physical environment. A head mountable system may have a transparent or translucent display, rather than an opaque display. The transparent or translucent display can have a medium through which light is directed to a user's eyes. The display may utilize various display technologies, such as uLEDs, OLEDs, LEDs, liquid crystal on silicon, laser scanning light source, digital light projection, or combinations thereof. An optical waveguide, an optical reflector, a hologram medium, an optical combiner, combinations thereof, or other similar technologies can be used for the medium. In some implementations, the transparent or translucent display can be selectively controlled to become opaque. Projection-based systems can utilize retinal projection technology that projects images onto users' retinas. Projection systems can also project virtual objects into the physical environment (e.g., as a hologram or onto a physical surface).

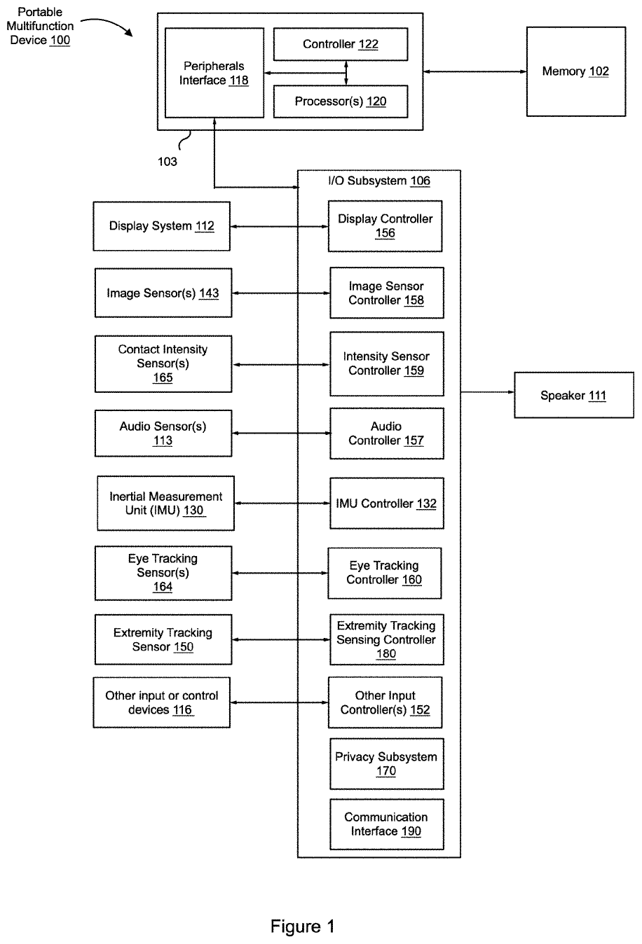

FIG. 1 is a block diagram of an example of a portable multifunction device 100 (sometimes also referred to herein as the “electronic device 100” for the sake of brevity) in accordance with some implementations. The electronic device 100 includes memory 102 (which optionally includes one or more computer readable storage mediums), a memory controller 122, one or more processing units (CPUs) 120, a peripherals interface 118, an input/output (I/O) subsystem 106, a speaker 111, a display system 112, an inertial measurement unit (IMU) 130, image sensor(s) 143 (e.g., camera), contact intensity sensor(s) 165, audio sensor(s) 113 (e.g., microphone), eye tracking sensor(s) 164 (e.g., included within a head-mountable device (HMD)), an extremity tracking sensor 150, and other input or control device(s) 116. In some implementations, the electronic device 100 corresponds to one of a mobile phone, tablet, laptop, wearable computing device, head-mountable device (HMD), head-mountable enclosure (e.g., the electronic device 100 slides into or otherwise attaches to a head-mountable enclosure), or the like. In some implementations, the head-mountable enclosure is shaped to form a receptacle for receiving the electronic device 100 with a display.

In some implementations, the peripherals interface 118, the one or more processing units 120, and the memory controller 122 are, optionally, implemented on a single chip, such as a chip 103. In some other implementations, they are, optionally, implemented on separate chips.

The I/O subsystem 106 couples input/output peripherals on the electronic device 100, such as the display system 112 and the other input or control devices 116, with the peripherals interface 118. The I/O subsystem 106 optionally includes a display controller 156, an image sensor controller 158, an intensity sensor controller 159, an audio controller 157, an eye tracking controller 160, one or more input controllers 152 for other input or control devices, an IMU controller 132, an extremity tracking controller 180, a privacy subsystem 170, and a communication interface 190. The one or more input controllers 152 receive/send electrical signals from/to the other input or control devices 116. The other input or control devices 116 optionally include physical buttons (e.g., push buttons, rocker buttons, etc.), dials, slider switches, joysticks, click wheels, and so forth. In some alternate implementations, the one or more input controllers 152 are, optionally, coupled with any (or none) of the following: a keyboard, infrared port, Universal Serial Bus (USB) port, stylus, finger-wearable device, and/or a pointer device such as a mouse. The one or more buttons optionally include an up/down button for volume control of the speaker 111 and/or audio sensor(s) 113. The one or more buttons optionally include a push button. In some implementations, the other input or control devices 116 includes a positional system (e.g., GPS) that obtains information concerning the location and/or orientation of the electronic device 100 relative to a particular object. In some implementations, the other input or control devices 116 include a depth sensor and/or a time of flight sensor that obtains depth information characterizing a particular object.

The display system 112 provides an input interface and an output interface between the electronic device 100 and a user. The display controller 156 receives and/or sends electrical signals from/to the display system 112. The display system 112 displays visual output to the user. The visual output optionally includes graphics, text, icons, video, and any combination thereof (collectively termed “graphics”). In some implementations, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

The display system 112 has a touch-sensitive surface, sensor, or set of sensors that accepts input from the user based on haptic and/or tactile contact. The display system 112 and the display controller 156 (along with any associated modules and/or sets of instructions in the memory 102) detect contact (and any movement or breaking of the contact) on the display system 112 and converts the detected contact into interaction with user-interface objects (e.g., one or more soft keys, icons, web pages or images) that are displayed on the display system 112. In an example implementation, a point of contact between the display system 112 and the user corresponds to a finger of the user or a finger-wearable device.

The display system 112 optionally uses LCD (liquid crystal display) technology, LPD (light emitting polymer display) technology, or LED (light emitting diode) technology, although other display technologies are used in other implementations. The display system 112 and the display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with the display system 112.

The display system 112 may correspond to a touch-sensitive display system. For example, a user optionally makes contact with the display system 112 using any suitable object or appendage, such as a stylus, a finger-wearable device, a finger, and so forth. In some implementations, the user interface is designed to work with finger-based contacts and gestures, which can be less precise than stylus-based input due to the larger area of contact of a finger on the touch screen. In some implementations, the electronic device 100 translates the rough finger-based input into a precise pointer/cursor position or command for performing the actions desired by the user.

The speaker 111 and the audio sensor(s) 113 provide an audio interface between a user and the electronic device 100. Audio circuitry receives audio data from the peripherals interface 118, converts the audio data to an electrical signal, and transmits the electrical signal to the speaker 111. The speaker 111 converts the electrical signal to human-audible sound waves. Audio circuitry also receives electrical signals converted by the audio sensors 113 (e.g., a microphone) from sound waves. Audio circuitry converts the electrical signal to audio data and transmits the audio data to the peripherals interface 118 for processing. Audio data is, optionally, retrieved from and/or transmitted to the memory 102 and/or RF circuitry by the peripherals interface 118. In some implementations, audio circuitry also includes a headset jack. The headset jack provides an interface between audio circuitry and removable audio input/output peripherals, such as output-only headphones or a headset with both output (e.g., a headphone for one or both ears) and input (e.g., a microphone).

The inertial measurement unit (IMU) 130 includes accelerometers, gyroscopes, and/or magnetometers in order to measure various forces, angular rates, and/or magnetic field information with respect to the electronic device 100. Accordingly, according to various implementations, the IMU 130 detects one or more positional change inputs of the electronic device 100, such as the electronic device 100 being shaken, rotated, moved in a particular direction, and/or the like.

The image sensor(s) 143 capture still images and/or video. In some implementations, an image sensor 143 is located on the back of the electronic device 100, opposite a touch screen on the front of the electronic device 100, so that the touch screen is enabled for use as a viewfinder for still and/or video image acquisition. In some implementations, another image sensor 143 is located on the front of the electronic device 100 so that the user's image is obtained (e.g., for selfies, for videoconferencing while the user views the other video conference participants on the touch screen, etc.). In some implementations, the image sensor(s) are integrated within an HMD.

The contact intensity sensors 165 detect intensity of contacts on the electronic device 100 (e.g., a touch input on a touch-sensitive surface of the electronic device 100). The contact intensity sensors 165 are coupled with the intensity sensor controller 159 in the I/O subsystem 106. The contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). The contact intensity sensor(s) 165 receive contact intensity information (e.g., pressure information or a proxy for pressure information) from the physical environment. In some implementations, at least one contact intensity sensor 165 is collocated with, or proximate to, a touch-sensitive surface of the electronic device 100. In some implementations, at least one contact intensity sensor 165 is located on the side of the electronic device 100.

The eye tracking sensor(s) 164 detect an eye gaze of a user of the electronic device 100 and generate eye tracking data indicative of the eye gaze of the user. In various implementations, the eye tracking data includes data indicative of a fixation point (e.g., point of regard) of the user on a display panel, such as a display panel within a head-mountable device (HMD), a head-mountable enclosure, or within a heads-up display.

The extremity tracking sensor 150 obtains extremity tracking data indicative of a position of an extremity of a user. For example, in some implementations, the extremity tracking sensor 150 corresponds to a hand tracking sensor that obtains hand tracking data indicative of a position of a hand or a finger of a user within a particular object. In some implementations, the extremity tracking sensor 150 utilizes computer vision techniques to estimate the pose of the extremity based on camera images.

In various implementations, the electronic device 100 includes a privacy subsystem 170 that includes one or more privacy setting filters associated with user information, such as user information included in extremity tracking data, eye gaze data, and/or body position data associated with a user. In some implementations, the privacy subsystem 170 selectively prevents and/or limits the electronic device 100 or portions thereof from obtaining and/or transmitting the user information. To this end, the privacy subsystem 170 receives user preferences and/or selections from the user in response to prompting the user for the same. In some implementations, the privacy subsystem 170 prevents the electronic device 100 from obtaining and/or transmitting the user information unless and until the privacy subsystem 170 obtains informed consent from the user. In some implementations, the privacy subsystem 170 anonymizes (e.g., scrambles or obscures) certain types of user information. For example, the privacy subsystem 170 receives user inputs designating which types of user information the privacy subsystem 170 anonymizes As another example, the privacy subsystem 170 anonymizes certain types of user information likely to include sensitive and/or identifying information, independent of user designation (e.g., automatically).

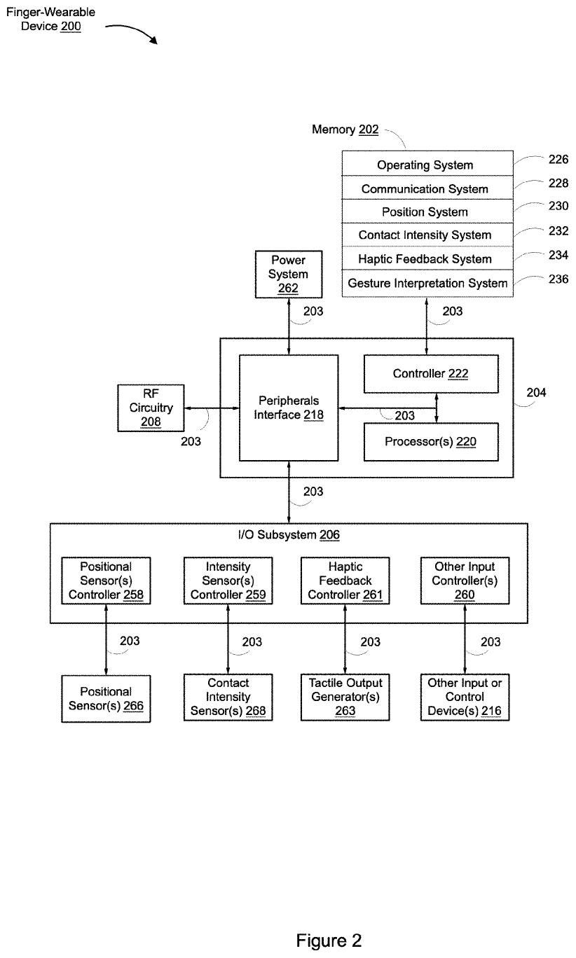

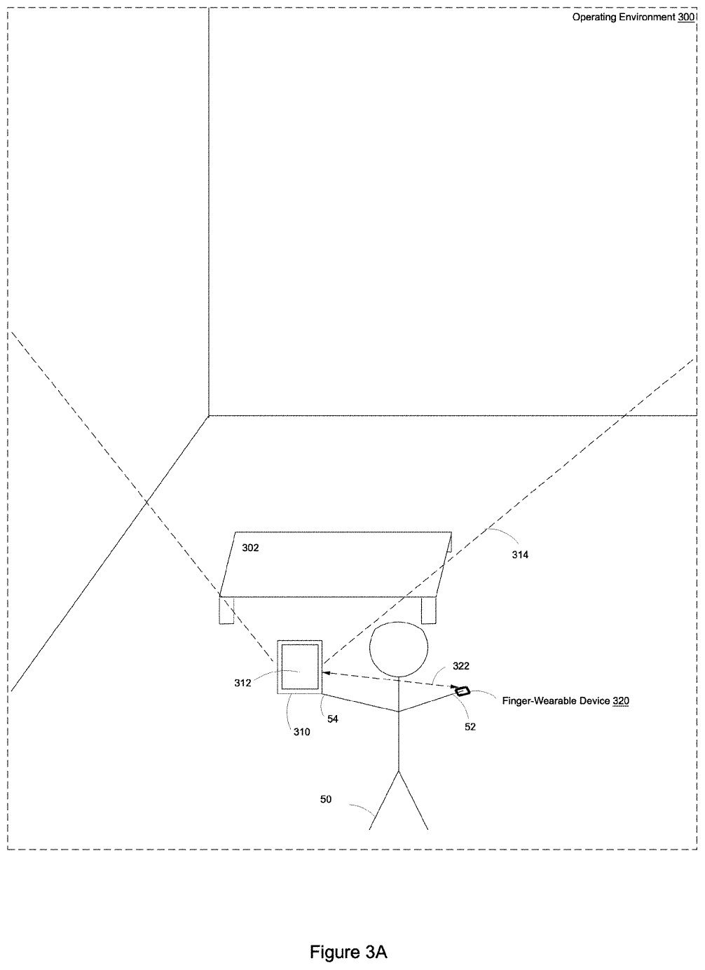

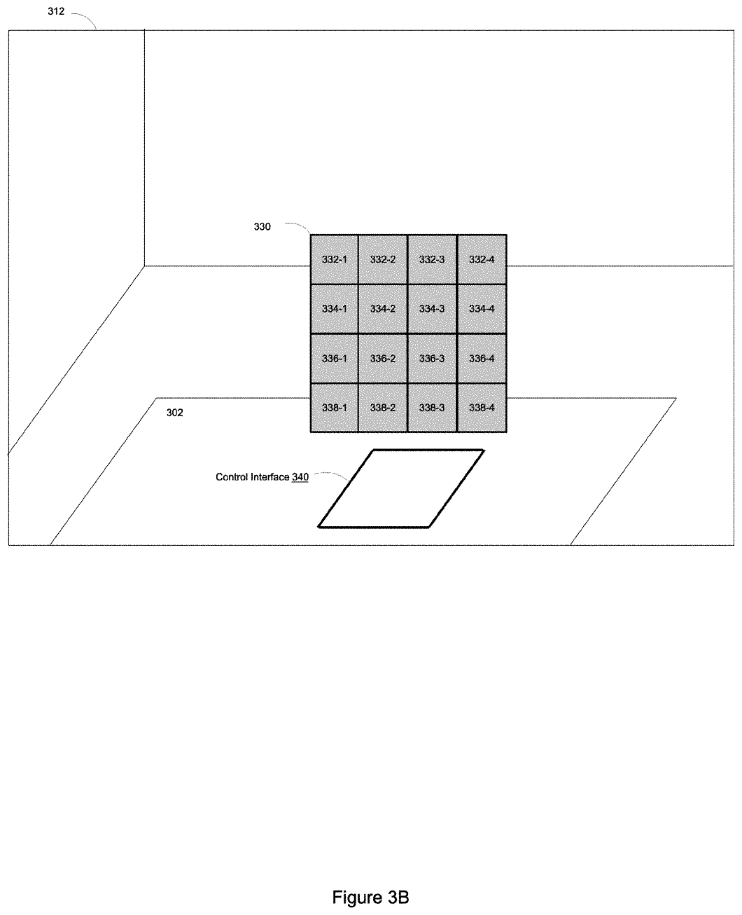

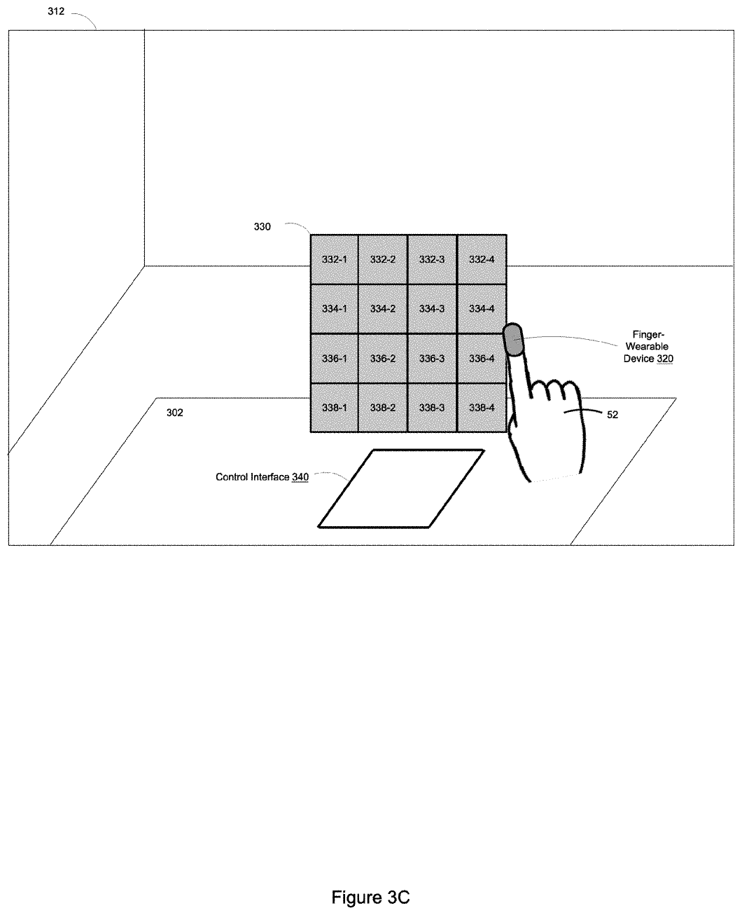

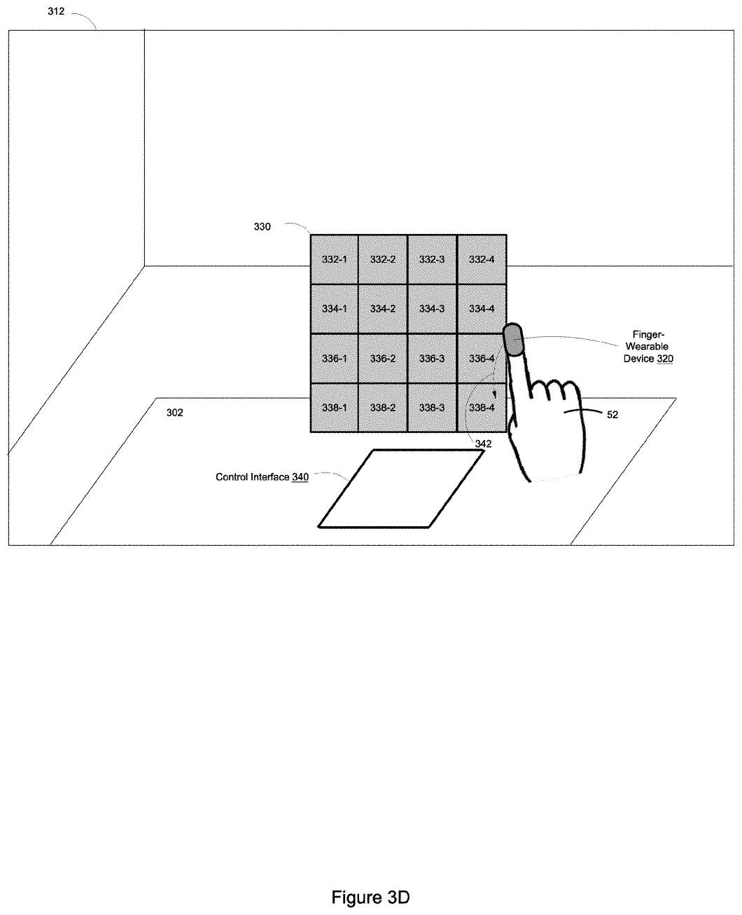

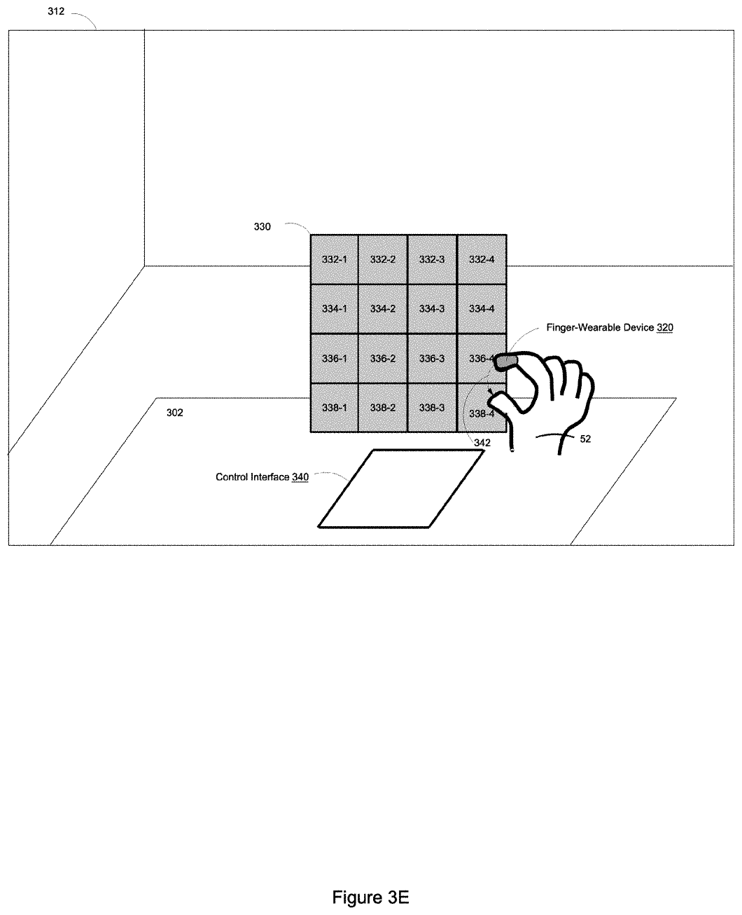

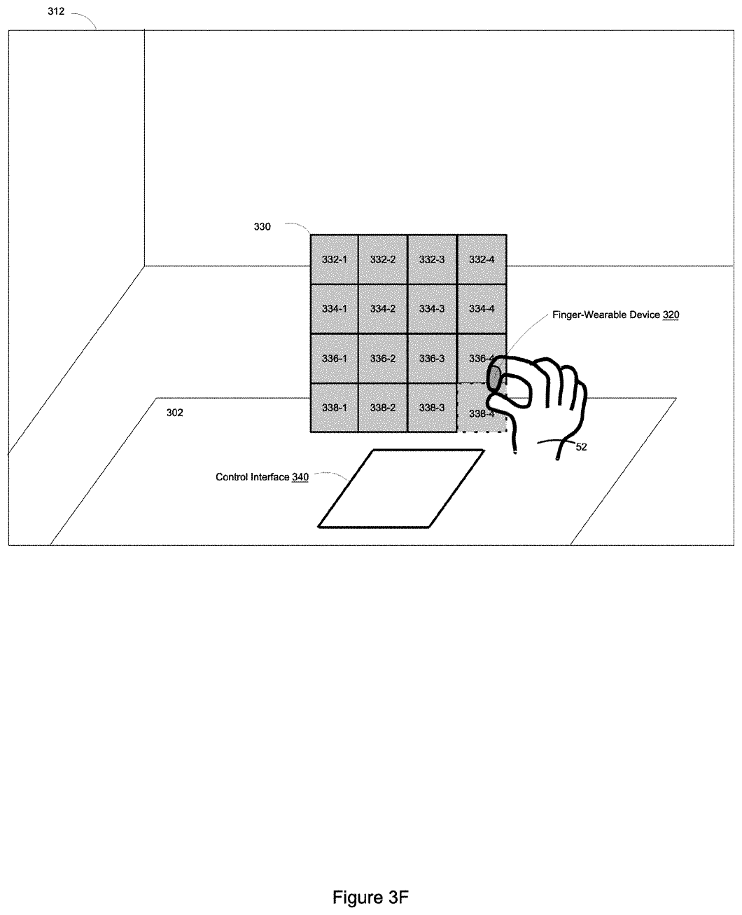

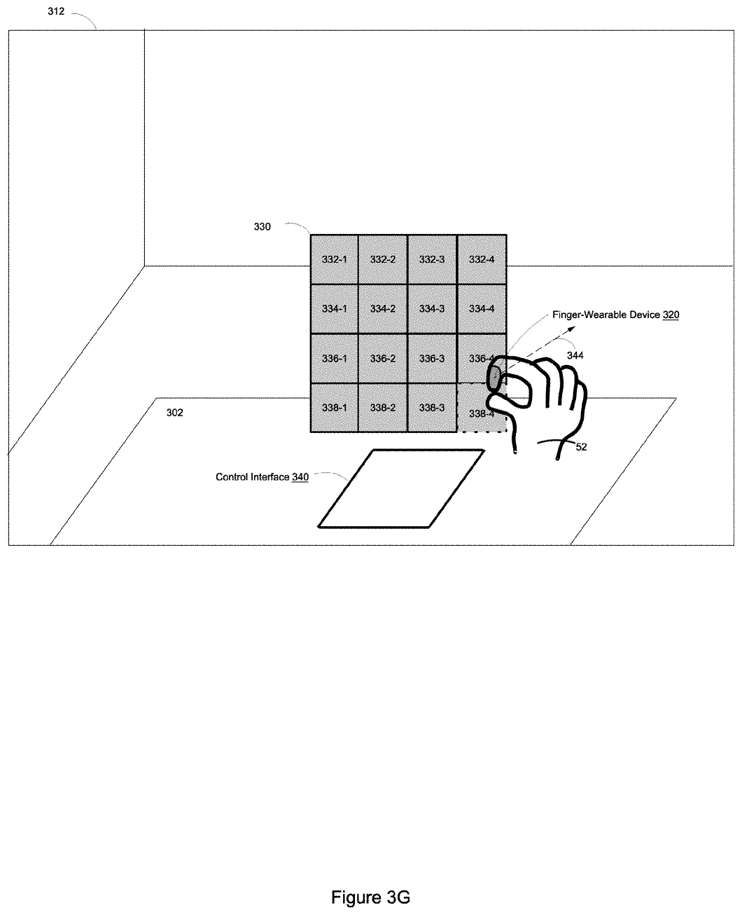

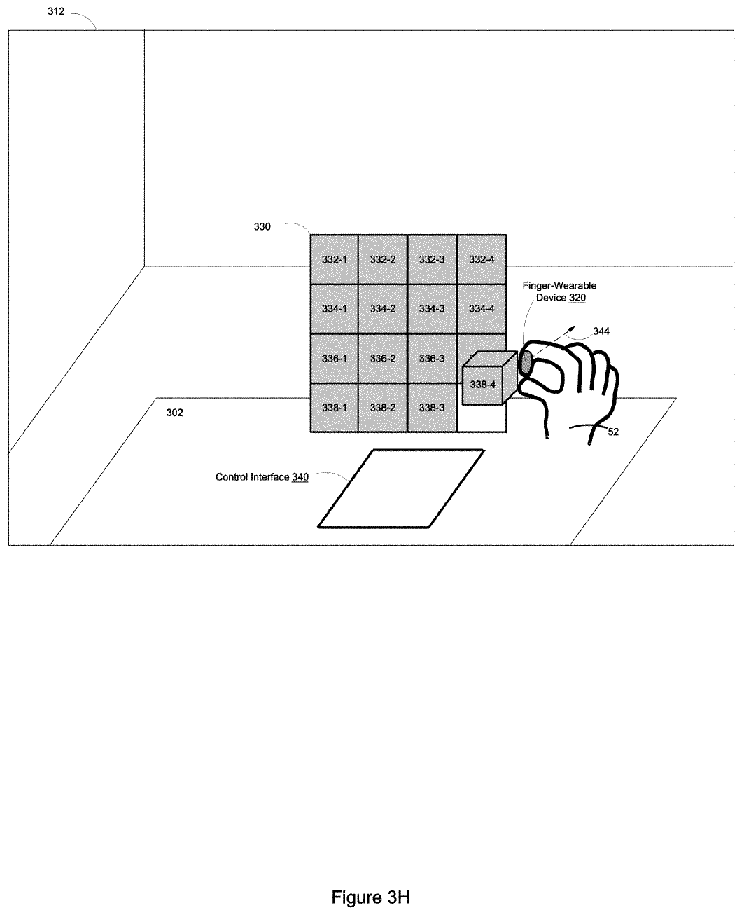

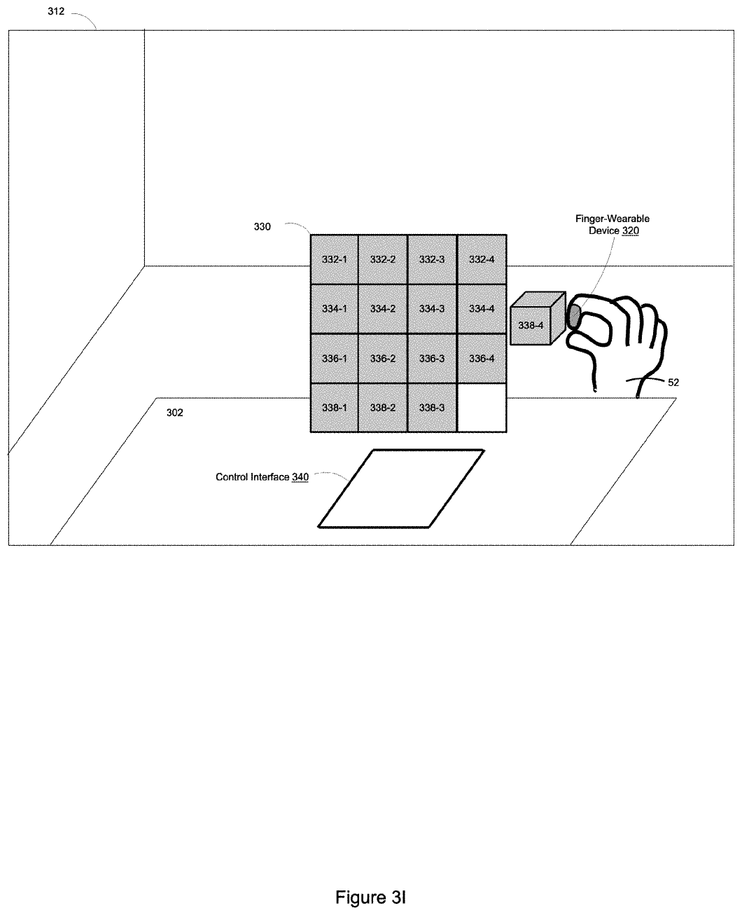

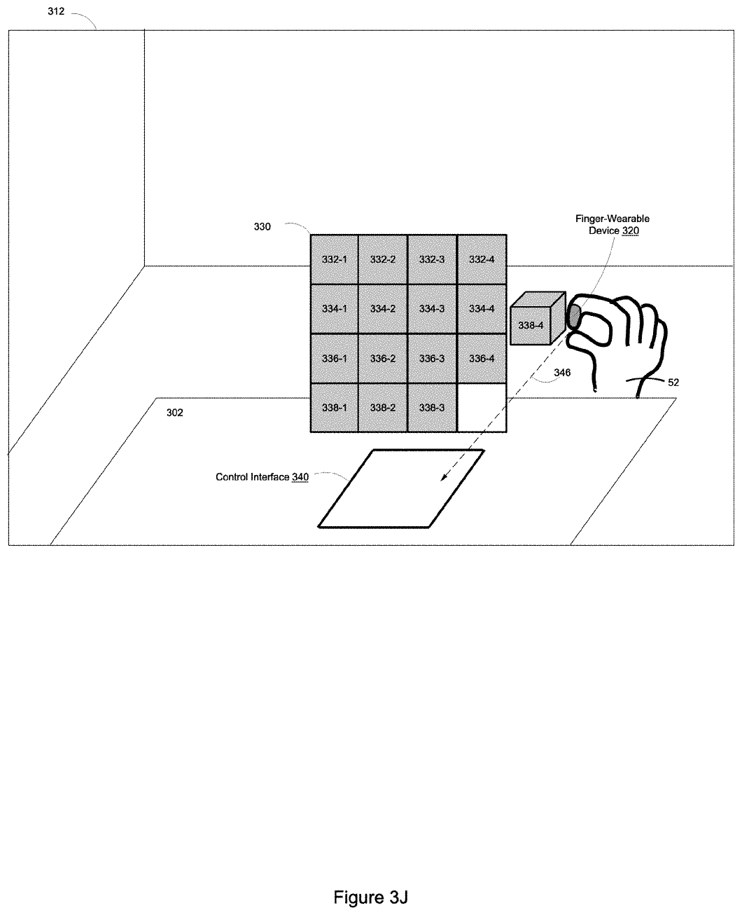

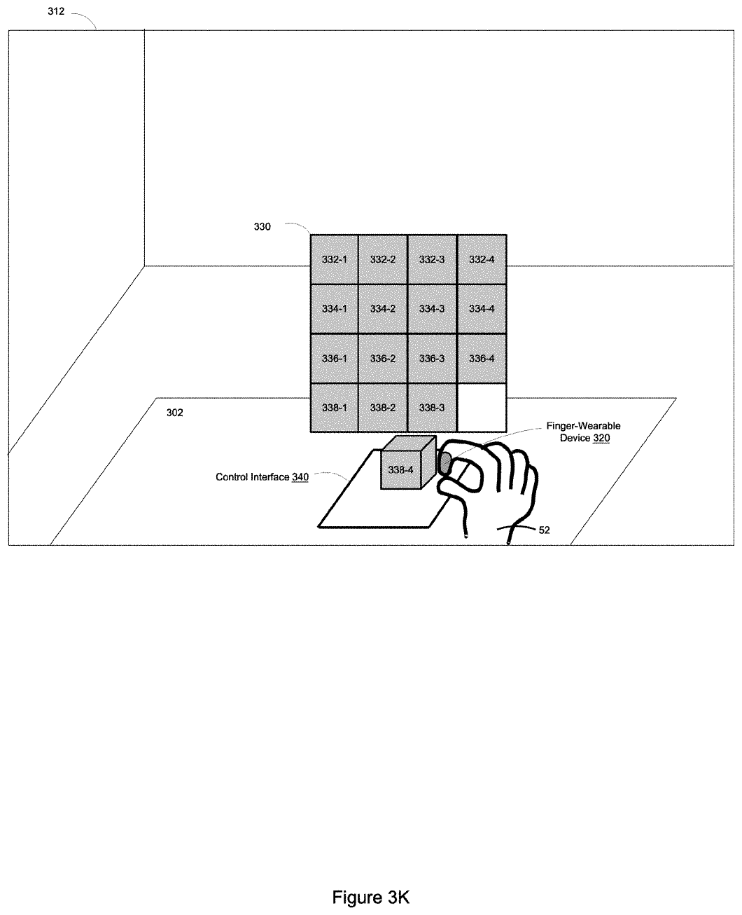

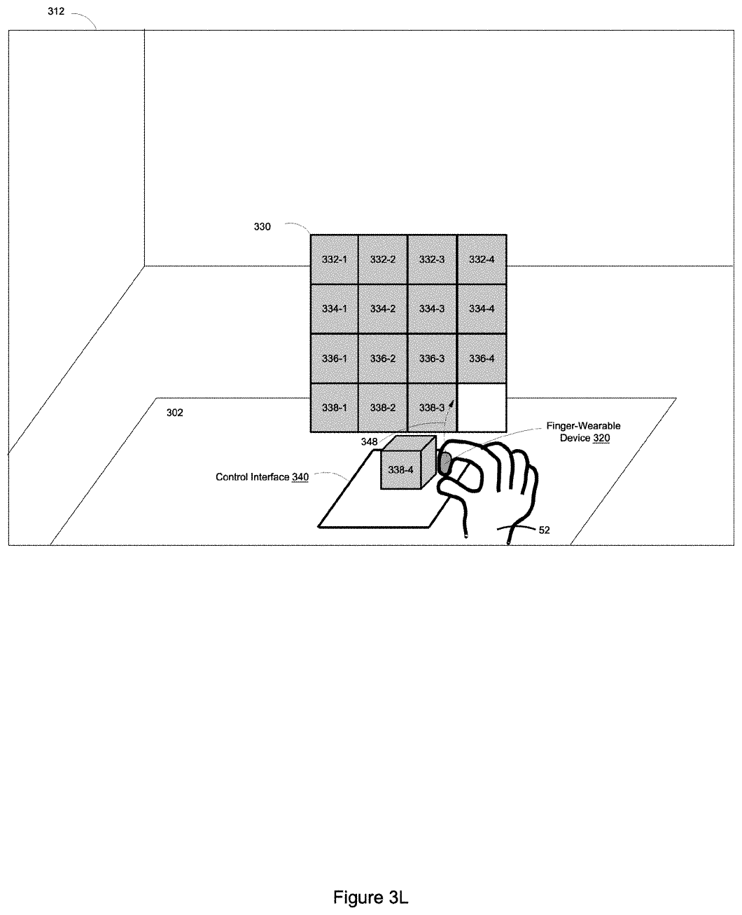

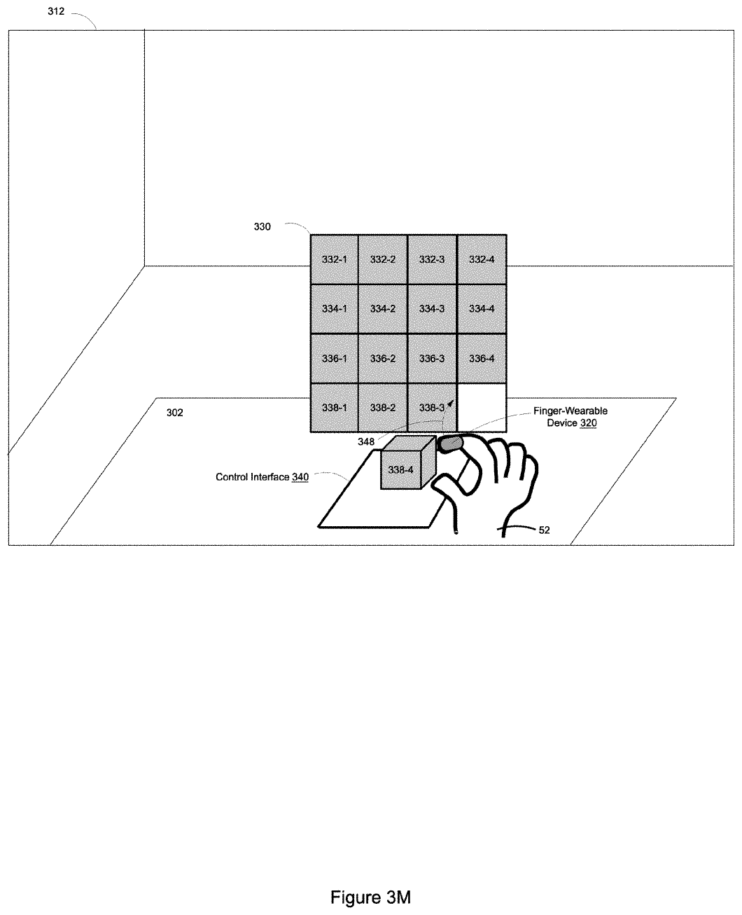

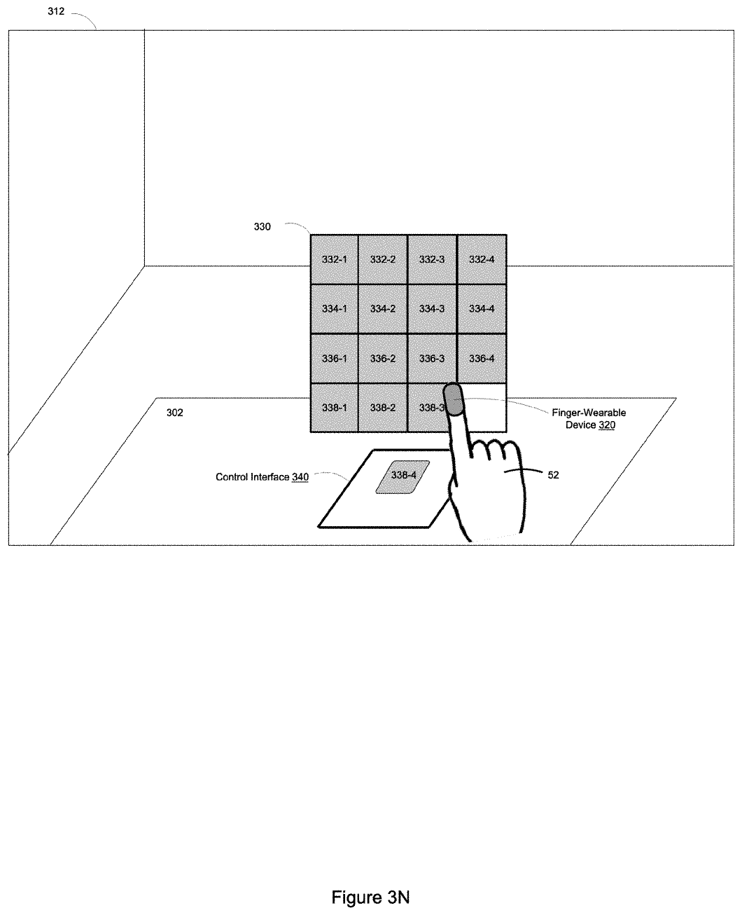

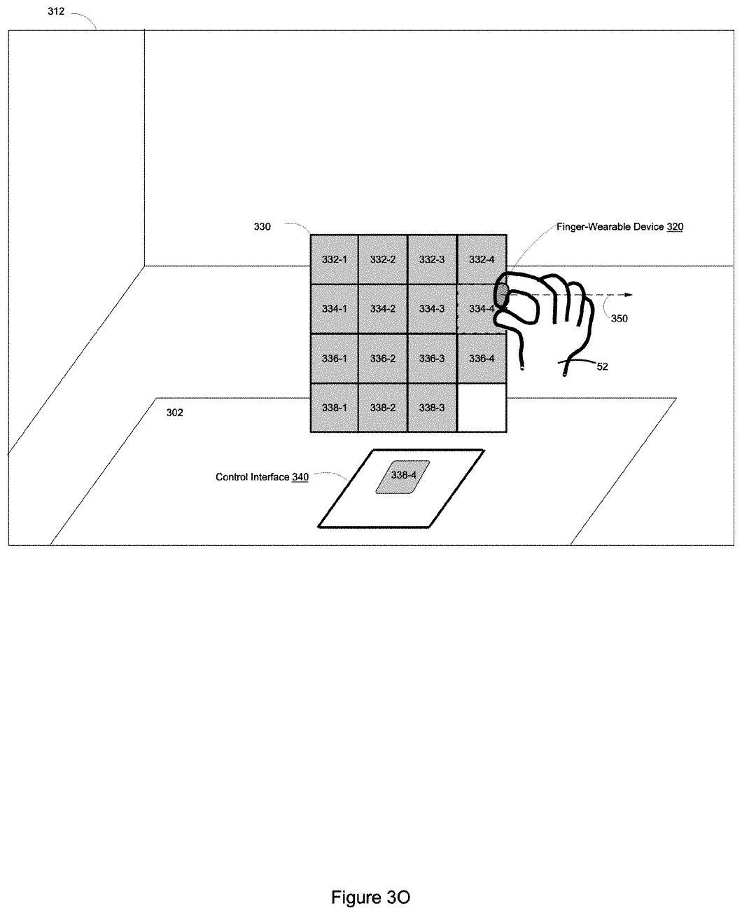

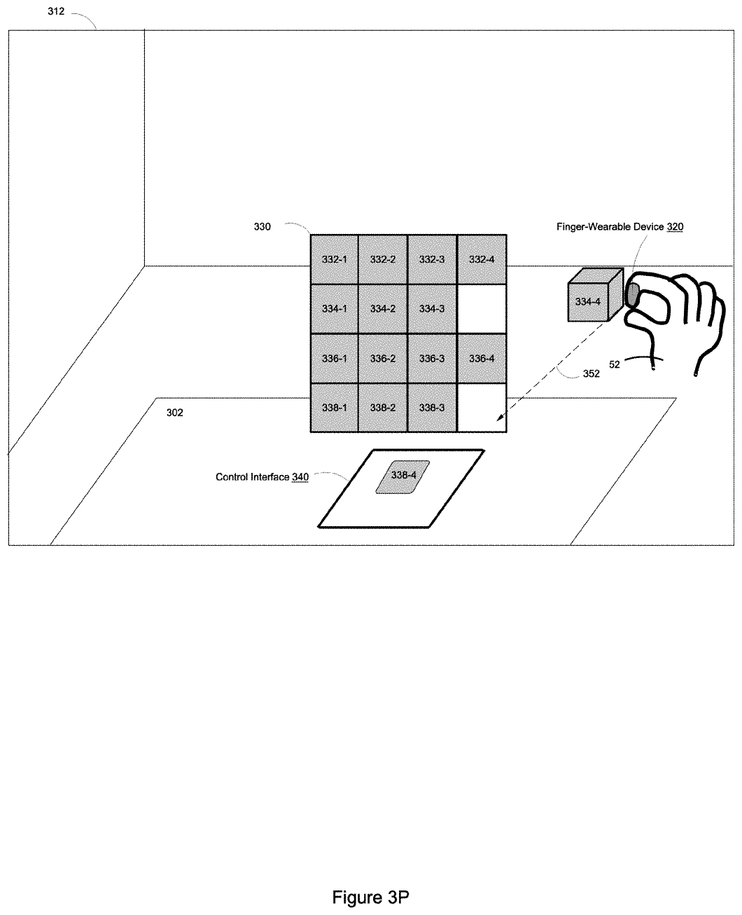

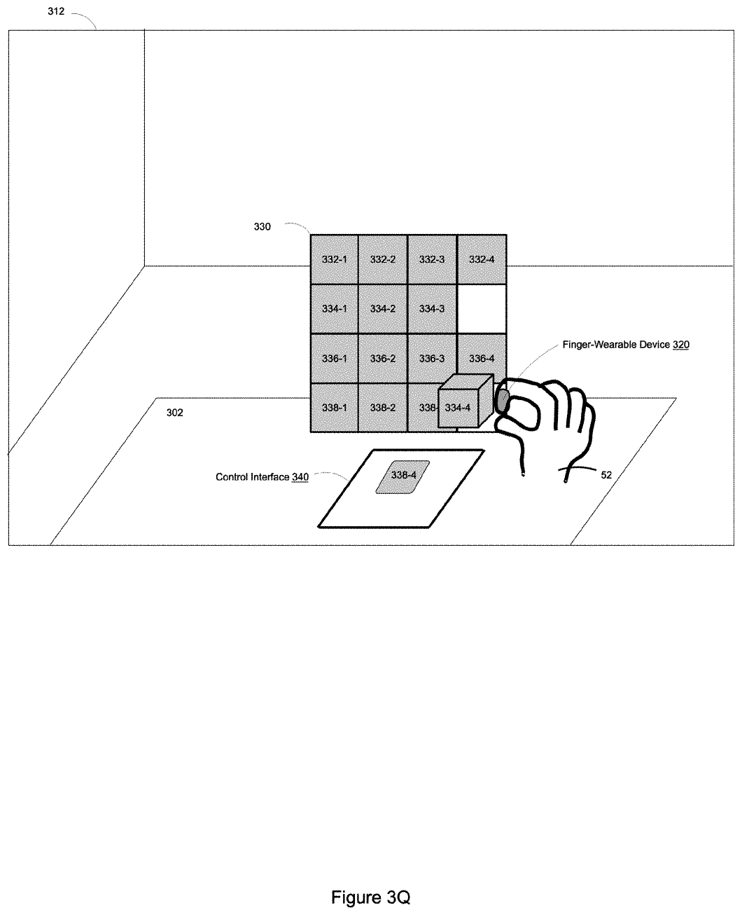

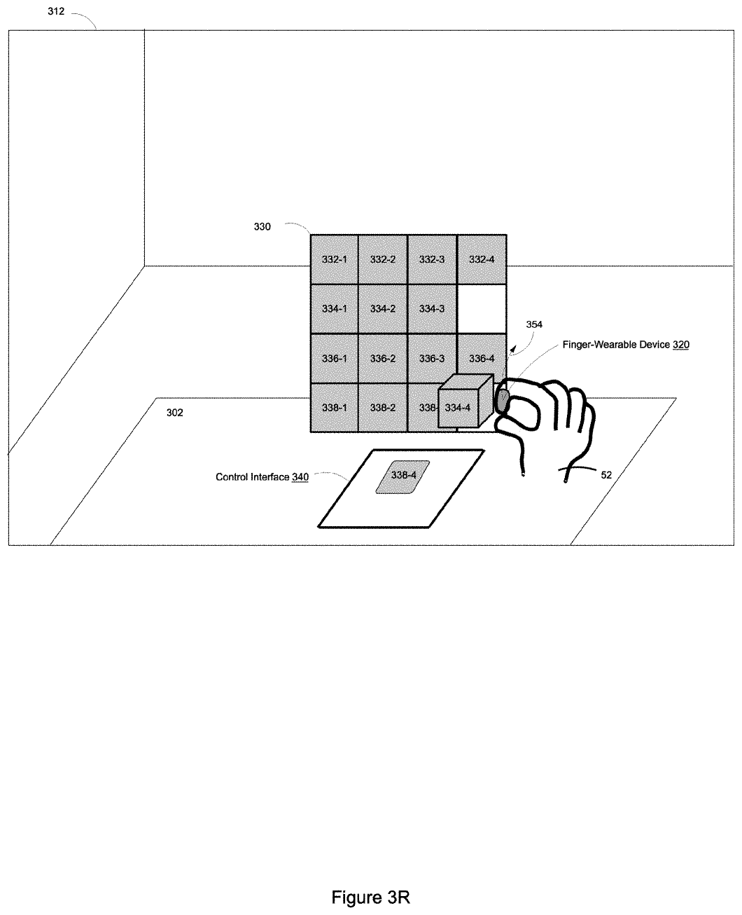

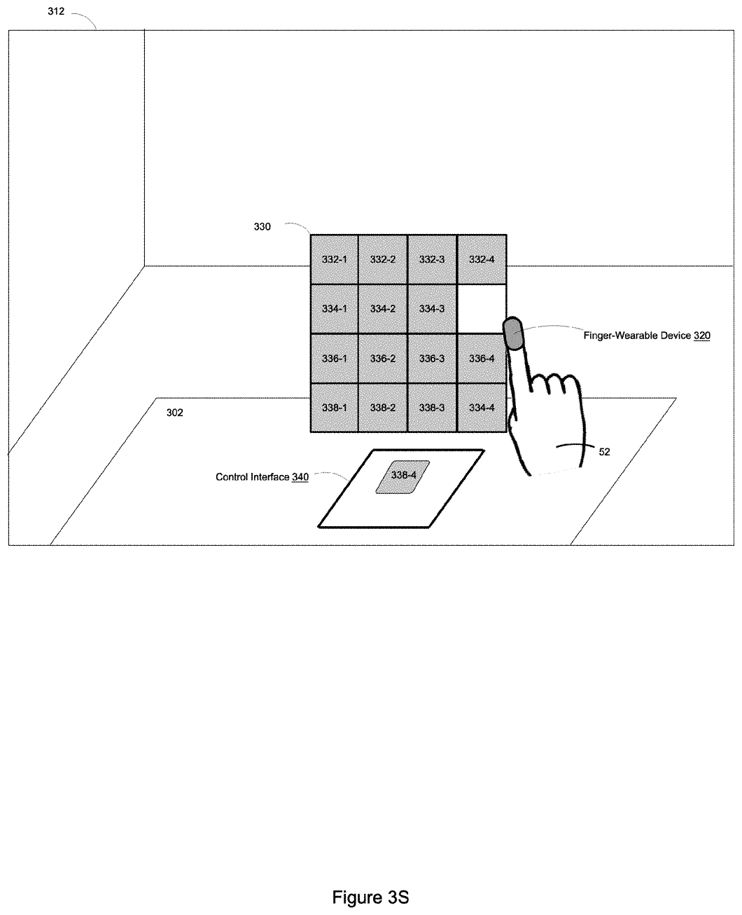

The electronic device 100 includes a communication interface 190 that is provided to communicate with a finger-wearable device, such as the finger-wearable device 200 illustrated in FIG. 2 or the finger-wearable device 320 in FIGS. 3A-3Q. For example, the communication interface 190 corresponds to one of a BLUETOOTH interface, IEEE 802.11x interface, near field communication (NFC) interface, and/or the like. According to various implementations, the electronic device 100 obtains finger manipulation data from the finger-wearable device via the communication interface 190, as will be further described below.

FIG. 2 is a block diagram of an example of a finger-wearable device 200. The finger-wearable device 200 includes memory 202 (which optionally includes one or more computer readable storage mediums), a memory controller 222, one or more processing units (CPUs) 220, a peripherals interface 218, RF circuitry 208, and an input/output (I/O) subsystem 206. These components optionally communicate over one or more communication buses or signal lines 203. One of ordinary skill in the art will appreciate that the finger-wearable device 200 illustrated in FIG. 2 is one example of a finger-wearable device, and that the finger-wearable device 200 optionally has more or fewer components than shown, optionally combines two or more components, or optionally has a different configuration or arrangement of the components. The various components shown in FIG. 2 are implemented in hardware, software, firmware, or a combination thereof, including one or more signal processing and/or application specific integrated circuits.

The finger-wearable device 200 includes a power system 262 for powering the various components. The power system 262 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices and/or portable accessories.

The memory 202 optionally includes high-speed random-access memory and optionally also includes non-volatile memory, such as one or more flash memory devices, or other non-volatile solid-state memory devices. Access to memory 202 by other components of the finger-wearable device 200, such as CPU(s) 220 and the peripherals interface 218, is, optionally, controlled by a memory controller 222.

The peripherals interface 218 can be used to couple input and output peripherals of the finger-wearable device 200 to the CPU(s) 220 and the memory 202. The one or more processors 220 run or execute various software programs and/or sets of instructions stored in memory 202 to perform various functions for the finger-wearable device 200 and to process data.

In some implementations, the peripherals interface 218, the CPU(s) 220, and the memory controller 222 are, optionally, implemented on a single chip, such as chip 204. In some implementations, they are implemented on separate chips.

The RF (radio frequency) circuitry 208 receives and sends RF signals, also called electromagnetic signals. The RF circuitry 208 converts electrical signals to/from electromagnetic signals and communicates with the electronic device 100 or 310, communications networks, and/or other communications devices via the electromagnetic signals. The RF circuitry 208 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 208 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), BLUETOOTH, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

The I/O subsystem 206 couples input/output peripherals on the finger-wearable device 200, such as other input or control devices 216, with the peripherals interface 218. The I/O subsystem 206 optionally includes one or more positional sensor controllers 258, one or more intensity sensor controllers 259, a haptic feedback controller 261, and one or more other input controllers 260 for other input or control devices. The one or more other input controllers 260 receive/send electrical signals from/to other input or control devices 216. The other input or control devices 216 optionally include physical buttons (e.g., push buttons, rocker buttons, etc.), dials, slider switches, click wheels, and so forth. In some implementations, the other input controller(s) 260 are, optionally, coupled with any (or none) of the following: an infrared port and/or a USB port.

In some implementations, the finger-wearable device 200 includes one or more positional sensors 266 that output positional data associated with the finger-wearable device 200. The positional data is indicative of a position, orientation, or movement of the finger-wearable device 200, such as a rotational movement or translational movement of the finger-wearable device 200. For example, the positional sensor(s) 266 include an inertial measurement unit (IMU) that provides 3D rotational data, such as roll, pitch, and yaw information. To that end, the IMU may include a combination of an accelerometer, gyroscopes, and magnetometers. As another example, the positional sensor(s) 266 include a magnetic sensor that provides 3D positional data and/or 3D orientation data, such as the position of the finger-wearable device 200. For example, the magnetic sensor measures weak magnetic fields in order to determine a position of the finger-wearable device 200.

In some implementations, the finger-wearable device 200 includes one or more contact intensity sensors 268 for detecting intensity (e.g., pressure) of a contact of finger, which is wearing the finger-wearable device 200, on a physical object. The one or more contact intensity sensors 268 output contact intensity data associated with the finger-wearable device 200. As one example, the contact intensity data is indicative of the pressure of a tap gesture associated with the finger tapping on a surface of a physical table. The one or more contact intensity sensors 268 may include an interferometer. The one or more contact intensity sensors 268 may include one or more piezoresistive strain gauges, capacitive force sensors, electric force sensors, piezoelectric force sensors, optical force sensors, capacitive touch-sensitive surfaces, or other intensity sensors.

The finger-wearable device 200 optionally includes one or more tactile output generators 263 for generating tactile outputs on the finger-wearable device 200. In some implementations, the term “tactile output” refers to physical displacement of an accessory (e.g., the finger-wearable device 200) of an electronic device (e.g., the electronic device 100) relative to a previous position of the accessory, physical displacement of a component of an accessory relative to another component of the accessory, or displacement of the component relative to a center of mass of the accessory that will be detected by a user with the user's sense of touch. For example, in situations where the accessory or the component of the accessory is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the accessory or the component of the accessory. For example, movement of a component (e.g., the housing of the finger-wearable device 200) is, optionally, interpreted by the user as a “click” of a physical actuator button. In some cases, a user will feel a tactile sensation such as a “click” even when there is no movement of a physical actuator button associated with the finger-wearable device that is physically pressed (e.g., displaced) by the user's movements. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., a “click,”), unless otherwise stated, the generated tactile output corresponds to physical displacement of the electronic device or a component thereof that will generate the described sensory perception for a typical (or average) user.

FIG. 2 shows the tactile output generator(s) 263 coupled with a haptic feedback controller 261. The tactile output generator(s) 263 optionally include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the electronic device). The tactile output generator(s) 263 receive tactile feedback generation instructions from a haptic feedback system 234 and generates tactile outputs on the finger-wearable device 200 that are capable of being sensed by a user of the finger-wearable device 200.

In some implementations, the software components stored in the memory 202 include an operating system 226, a communication system (or set of instructions) 228, a position system (or set of instructions) 230, a contact intensity system (or set of instructions) 232, a haptic feedback system (or set of instructions) 234, and a gesture interpretation system (or set of instructions) 236. Furthermore, in some implementations, the memory 202 stores a device/global internal state associated with the finger-wearable device. The device/global internal state includes one or more of: sensor state, including information obtained from the finger wearable device's various sensors and other input or control devices 216; positional state, including information regarding the finger-wearable device's position (e.g., position, orientation, tilt, roll and/or distance) relative to an electronic device (e.g., the electronic device 100); and location information concerning the finger-wearable device's absolute position.

The operating system 226 includes various software components and/or drivers for controlling and managing general system tasks (e.g., memory management, power management, etc.) and facilitates communication between various hardware and software components.

The communication system 228 facilitates communication with other devices (e.g., the electronic device 100 or the electronic device 310), and also includes various software components (e.g., for handling data received by the RF circuitry 208) that are adapted for coupling directly to other devices or indirectly over a network (e.g., the Internet, wireless LAN, etc.).

The position system 230, in conjunction with positional data from the one or more positional sensor(s) 266, optionally detects positional information concerning the finger-wearable device 200. The position system 230 optionally includes software components for performing various operations related to detecting the position of the finger-wearable device 200 and detecting changes to the position of the finger-wearable device 200 in a particular frame of reference. In some implementations, the position system 230 detects the positional state of the finger-wearable device 200 relative to the electronic device and detects changes to the positional state of the finger-wearable device 200 relative to the electronic device. As noted above, in some implementations, the electronic device 100 or 310 determines the positional state of the finger-wearable device 200 relative to the electronic device and changes to the positional state of the finger-wearable device 200 using information from the position system 230.

The contact intensity system 232, in conjunction with contact intensity data from the one or more contact intensity sensor(s) 268, optionally detects contact intensity information associated with the finger-wearable device 200. The contact intensity system 232 includes software components for performing various operations related to detection of contact, such as detecting the intensity and/or duration of a contact between the finger-wearable device 200 and a desk surface. Determining movement of the point of contact, which is represented by a series of contact intensity data, optionally includes determining speed (magnitude), velocity (magnitude and direction), and/or an acceleration (a change in magnitude and/or direction) of the point of contact.

The haptic feedback system 234 includes various software components for generating instructions used by the tactile output generator(s) 263 to produce tactile outputs at one or more locations on finger-wearable device 200 in response to user interactions with the finger-wearable device 200.

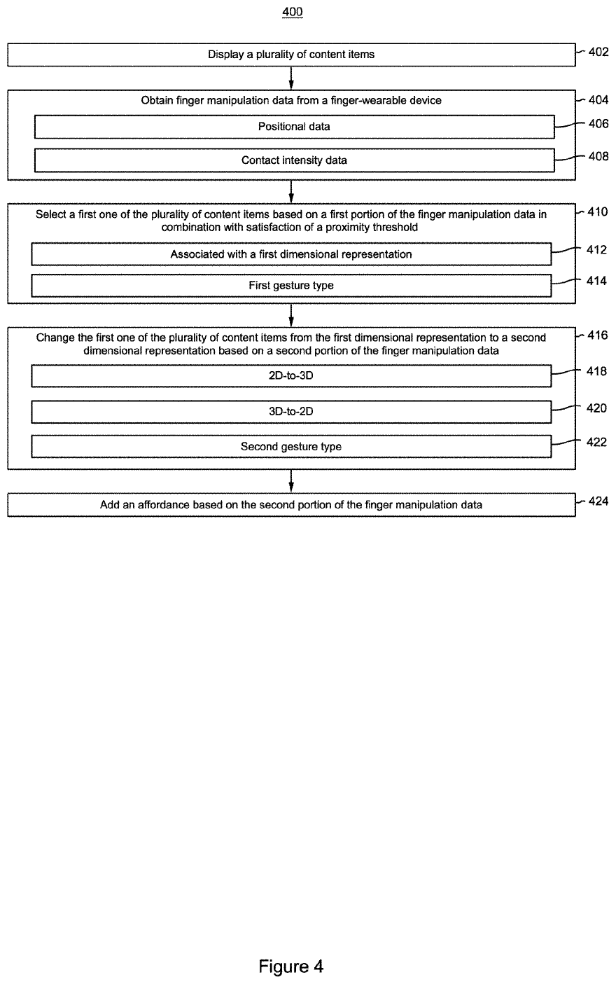

The finger-wearable device 200 optionally includes a gesture interpretation system 236. The gesture interpretation system 236 coordinates with the position system 230 and/or the contact intensity system 232 in order to determine a gesture performed by the finger-wearable device. For example, the gesture includes one or more of: a pinch gesture, a pull gesture, a pinch and pull gesture, a rotational gesture, a tap gesture, and/or the like. In some implementations, the finger-wearable device 200 does not include a gesture interpretation system, and an electronic device or a system (e.g., the gesture interpretation system 445 in FIG. 4) determines a gesture performed by the finger-wearable device 200 based on finger manipulation data from the finger-wearable device 200. In some implementations, a portion of the gesture determination is performed at the finger-wearable device 200, and a portion of the gesture determination is performed at an electronic device/system. In some implementations, the gesture interpretation system 236 determines a time duration associated with a gesture. In some implementations, the gesture interpretation system 236 determines a contact intensity associated with a gesture, such as an amount of pressure associated with a finger, which is wearing the finger-wearable device 200, tapping on a physical surface.

Each of the above identified modules and applications correspond to a set of executable instructions for performing one or more functions described above and the methods described in this application (e.g., the computer-implemented methods and other information processing methods described herein). These systems (i.e., sets of instructions) need not be implemented as separate software programs, procedures or modules, and thus various subsets of these modules are, optionally, combined or otherwise re-arranged in various embodiments. In some implementations, the memory 202 optionally stores a subset of the systems and data structures identified above. Furthermore, the memory 202 optionally stores additional systems and data structures not described above.

FIGS. 3A-3S are examples of an electronic device 310 changing dimensional representations of respective content items in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein.

As illustrated in FIG. 3A, an electronic device 310 is associated with (e.g., operates according to) an operating environment 300. In some implementations, the electronic device 310 is similar to and adapted from the electronic device 100 in FIG. 1. In some implementations, the electronic device 310 generates one of the XR settings described above.

The electronic device 310 includes a display 312 that is associated with a viewable region 314 of the operating environment 300. For example, in some implementations, the electronic device 310 includes an image sensor associated with a field-of-view corresponding to the viewable region 314, and the electronic device 310 composites pass-through image data from the image sensor with computer-generated content. As another example, in some implementations, the electronic device 310 includes a see-through display 312 that enables ambient light to enter from a portion of a physical environment that is associated with the viewable region 314. The operating environment 300 includes a physical table 302, and the viewable region 314 includes a portion of the physical table 302.

A finger-wearable device 320 is worn on a finger of a first hand 52 of a user 50. In some implementations, the finger-wearable device 320 is similar to and adapted from the finger-wearable device 200 illustrated in FIG. 2.

The electronic device 310 includes a communication interface (e.g., the communication interface 190 in FIG. 1) that is provided to communicate with the finger-wearable device 320. The electronic device 310 establishes a communication link with the finger-wearable device 320, as is indicated by a communication link line 322. Establishing the link between the electronic device 310 and the finger-wearable device 320 may be referred to as pairing or tethering. One of ordinary skill in the art will appreciate that the electronic device 310 may communicate with the finger-wearable device 320 according to a variety of communication protocols, such as BLUETOOTH, IEEE 802.11x, NFC, etc. The electronic device 310 obtains finger manipulation data from the finger-wearable device 320 via the communication interface. For example, the electronic device 310 obtains a combination of positional data (e.g., output by positional sensor(s) of the finger-wearable device 320) and contact intensity data (e.g., output by contact intensity sensor(s) of the finger-wearable device 320).

In some implementations, a second hand 54 of the user 50 is holding the electronic device 310. For example, in some implementations, the electronic device 310 corresponds to one of a smartphone, laptop, tablet, etc.

In some implementations, the electronic device 310 corresponds to a head-mountable device (HMD) that includes an integrated display (e.g., a built-in display) that displays a representation of the operating environment 300. In some implementations, the electronic device 310 includes a head-mountable enclosure. In various implementations, the head-mountable enclosure includes an attachment region to which another device with a display can be attached. In various implementations, the head-mountable enclosure is shaped to form a receptacle for receiving another device that includes a display (e.g., the electronic device 310). For example, in some implementations, the electronic device 310 slides/snaps into or otherwise attaches to the head-mountable enclosure. In some implementations, the display of the device attached to the head-mountable enclosure presents (e.g., displays) the representation of the operating environment 300. For example, in some implementations, the electronic device 310 corresponds to a mobile phone that can be attached to the head-mountable enclosure.

In some implementations, the electronic device 310 includes an image sensor, such as a scene camera. For example, the image sensor obtains image data that characterizes the operating environment 300, and the electronic device 310 composites the image data with computer-generated content in order to generate display data for display on the display 312. The display data may be characterized by an XR environment. For example, the image sensor obtains image data that represents the portion of the physical table 302, and the generated display data displayed on the display 312 displays respective representations of the portion of the physical table 302 (See FIG. 3B).

In some implementations, the electronic device 310 includes a see-through display. The see-through display permits ambient light from the physical environment through the see-through display, and the representation of the physical environment is a function of the ambient light. For example, the see-through display is a translucent display, such as glasses with optical see-through. In some implementations, the see-through display is an additive display that enables optical see-through of the physical surface, such as an optical HMD (OHMD). For example, unlike purely compositing using a video stream, the additive display is capable of reflecting projected images off of the display while enabling the user to see through the display. In some implementations, the see-through display includes a photochromic lens. The HMD adds computer-generated objects to the ambient light entering the see-through display in order to enable display of the operating environment 300. For example, a see-through display 312 permits ambient light from the operating environment 300 that includes the portion of the physical table 302, and thus the see-through display 312 displays respective representations of the portion of the physical table 302 (See FIG. 3B).

As illustrated in FIG. 3B, the electronic device 310 displays, on the display 312, a representation of the portion of the physical table 302 (hereinafter sometimes referred to as “the portion of the physical table 302” or the “physical table 302” for the sake of brevity).

Moreover, the electronic device 310 displays, on the display 312, a plurality of content items 330. A particular one of the plurality of content items 330 may represent one of a variety of content types, such as audio content, video content, image content, file content, metadata content, database content, and/or the like.

In some implementations, the plurality of content items 330 is displayed according to a grid pattern (sometimes hereinafter referred to as “the grid 330”). For example, as illustrated in FIG. 3B, the grid pattern includes a matrix of two-dimensional (2D) tiles. The grid pattern includes a first row (e.g., tiles 332-1-332-4), a second row (e.g., tiles 334-1-334-4), a third row (e.g., tiles 336-1-336-4), and a fourth row (e.g., tiles 338-1-338-4). For example, each of the tiles is associated with a respective planar value (e.g., a depth value) within a threshold of each other. One of ordinary skill in the art will appreciate that the grid pattern may include any number of rows and columns, and may include tiles having different shapes and sizes. In some implementations, in addition to or instead of including 2D tiles, the plurality of content items includes three-dimensional (3D) representations, such as one or more cubes, one or more spheres, etc.

In some implementations, the plurality of content items 330 is spatially associated with a physical surface that is within a viewable region 314 on the display 312. For example, as illustrated in FIG. 3B, the plurality of content items 330 is positioned in order to be substantially orthogonal to the surface of the physical table 302.

In some implementations, as further illustrated in FIG. 3B, the electronic device 310 displays, on the display 312, a control interface 340. The control interface 340 is associated with the plurality of content items 330. For example, the control interface 340 is provided to facilitate user engagement with the plurality of content items 330, such as is described with reference to FIGS. 3J-3N.

As illustrated in FIG. 3C, the finger-wearable device 320 moves to within the viewable region 314, and thus the display 312 displays a representation of the finger-wearable device 320 (hereinafter sometimes “the finger-wearable device 320” for the sake of brevity).

As illustrated in FIGS. 3D-3F, in some implementations, the electronic device 310 selects a first one of the plurality of content items 338-4 based on a pinch gesture performed by the finger-wearable device 320 in combination with satisfaction of a proximity threshold. The first one of the plurality of content items 338-4 is associated with a first dimensional representation corresponding to a two-dimensional (2D) tile.

One of ordinary skill in the art will appreciate that, in some implementations, the electronic device 310 selects a particular content item based on a different gesture type (e.g., tap, double tap), or selects a particular content item based on satisfaction of a proximity threshold and independent of gesture type. For example, in some implementations, in response to determining that finger manipulation data indicates that the finger-wearable device 320 satisfies a proximity threshold (e.g., is positioned within) a particular content item, electronic device 310 selects the particular content item, independent of a gesture performed by the finger-wearable device 320.

In some implementations, the electronic device 310 selects the first one of the plurality of content items 338-4 based on a combination of a gesture performed by the finger-wearable device 320 and tracking data (e.g., eye tracking data or computer-vision based extremity tracking data) that is indicative of satisfaction of the proximity threshold. For example, while detecting the finger-wearable device 320 performing the pinch gesture outside of the viewable region of the display 312, the electronic device 310 determines, based on eye gaze data from an eye tracking system, that the user 50 is focused on (and thus satisfies the proximity threshold with respect to) the first one of the plurality of content items 338-4. As another example, the electronic device 310 detects the finger-wearable device 320 performing a gesture (e.g., pinch) within the viewable region of the display 312 but not in satisfaction of the proximity threshold, and the electronic device 310 instead determines that eye gaze data indicates user focus in satisfaction the proximity threshold. Accordingly, the electronic device 310 selects the first one of the plurality of content items 338-4 based on a combination of inputs from the finger-wearable device and from the eye tracking system.

As illustrated in FIG. 3D, the finger-wearable device 320 begins to perform the pinch gesture, as indicated by pinch line 342. The pinch line 342 is illustrated for purely explanatory purposes. As the finger-wearable device 320 performs the pinch gesture, the electronic device 310 obtains a first portion of the finger manipulation data from the finger-wearable device 320. The first portion of the finger manipulation data may include a combination of positional data and contact intensity data. For example, the positional data includes 3D rotational data (e.g., from an IMU sensor integrated in the finger-wearable device 320) and 3D positional data (e.g., from a magnetic sensor integrated in the finger-wearable device 320). In some implementations, upon detecting the start of the pinch gesture, the electronic device 310 displays, on the display 312, a visualization of the pinch gesture.

The electronic device 310 selects the first one of the plurality of content items 338-4 based on the first portion of the finger manipulation data in combination with satisfaction of a proximity threshold. For example, as illustrated in FIGS. 3D and 3E, the electronic device 310 determines that the finger-wearable device 320 rotates based on IMU data (e.g., a roll value, a pitch value, and a yaw value) included in the first portion of the finger manipulation data. As another example, illustrated in FIGS. 3D-3F, the electronic device 310 determines that the finger-wearable device 320 moves downwards towards the physical table 302 based on magnetic sensor data included in the first portion of the finger manipulation data. Accordingly, in some implementations, the electronic device 310 determines that the finger-wearable device 320 performs the pinch gesture based on a combination of the IMU data and the magnetic sensor data.

Moreover, the electronic device 310 determines that the pinch gesture satisfies the proximity threshold with respect to the first one of the plurality of content items 338-4. For example, based on first portion of the finger manipulation data, the electronic device 310 determines that, upon completion of the pinch gesture, the finger-wearable device 320 is positioned within the first one of the plurality of content items 338-4, as illustrated in FIG. 3F. In some implementations, the electronic device 310 determines satisfaction of the proximity threshold when the finger-wearable device 320 is outside of a particular content item but less than a threshold distance from the particular content item.

Thus, in response to detecting that the finger-wearable device 320 performs the pinch gesture and that the pinch gesture satisfies the proximity threshold, the electronic device 310 selects the first one of the plurality of content items 338-4. In some implementations, the electronic device 310 displays an indication of the selection. Namely, as illustrated in FIG. 3F, the electronic device 310 changes an appearance of the first one of the plurality of content items 338-4 from a solid line boundary to a dotted line boundary. Displaying the indicator provides feedback to the user 50, thereby reducing erroneous (e.g., unintended) inputs from the finger-wearable device 320 and reducing resource utilization by the electronic device 310.

As illustrated in FIG. 3G, the finger-wearable device 320 begins a movement of the first one of the plurality of content items 338-4 to outside of the grid 330. The movement of the first one of the plurality of content items 338-4 is indicated by movement line 344, which is illustrated for purely explanatory purposes. As the finger-wearable device 320 moves along the movement line 344, the electronic device 310 obtains a second portion of the finger manipulation data from the finger-wearable device 320.

The electronic device 310 changes the first one of the plurality of content items 338-4 from the first dimensional representation to a second dimensional representation based on the second portion of the finger manipulation data. Namely, as illustrated in FIGS. 3G and 3H, based on finger-wearable device 320 moving outside of the grid 330, the electronic device 310 changes the appearance of the first one of the plurality of content items 338-4 from a 2D tile to a 3D cube. Moreover, the electronic device 310 moves the 3D cube outside of the grid 330. As illustrated in FIG. 31, the finger-wearable device 320 completes the movement, and thus the electronic device 310 displays, on the display 312, the 3D representation of the first one of the plurality of content items 338-4 outside of the grid 330 and adjacent to the finger-wearable device 320.

As illustrated in FIGS. 3J-3N, the electronic device 310 changes the first one of the plurality of content items 338-4 from the 3D representation (e.g., the cube) to a 2D tile that is positioned within the control interface 340. As illustrated in FIGS. 3J and 3K, the finger-wearable device 320 moves to within the control interface 340, as indicated by movement line 346 (illustrated for purely explanatory purposes). Accordingly, based on finger manipulation data from the finger-wearable device 320, the electronic device 310 moves the 3D representation of the first one of the plurality of content items 338-4 to a corresponding location within the control interface 340.

As illustrated in FIGS. 3L-3N, the finger-wearable device 320 performs a de-pinch gesture (sometimes referred to as a “pinch release gesture”), as indicated by de-pinch line 348 (illustrated for purely explanatory purposes). As the finger-wearable device 320 performs the de-pinch gesture, the electronic device 310 obtains finger manipulation data from the finger-wearable device 320. Based on the finger manipulation data, the electronic device 310 determines that the finger-wearable device 320 performs the de-pinch gesture. In response to detecting the de-pinch gesture, the electronic device 310 changes the dimensional representation associated with the first one of the plurality of content items 338-4 from the 3D cube to the 2D tile. Accordingly, as illustrated in FIG. 3N, the first one of the plurality of content items 338-4 corresponds to a 2D tile positioned within the control interface 340.

In some implementations, based on moving the first one of the plurality of content items 338-4 to within the control interface 340, the electronic device 310 updates the control interface 340 in order to facilitate manipulation with content represented by the first one of the plurality of content items 338-4. For example, when the first one of the plurality of content items 338-4 represents audio content, the control interface 340 is updated to include audio manipulation affordances for manipulating the audio content, such as a volume control, pitch control, filter control, etc.

As another example, as illustrated in FIGS. 30-3S, the electronic device 310 rearranges a second one of the plurality of content items 334-4 within the grid 330. As illustrated in FIG. 30, the electronic device 310 has selected the second one of the plurality of content items 334-4 via a detected pinch gesture performed by the finger-wearable device 320. Namely, the electronic device 310 moves the second one of the plurality of content items 334-4 from the second row of the grid 330 to the fourth row of the grid 330.

As illustrated in FIGS. 30 and 3P, the finger-wearable device 320 performs a pull gesture with respect to the second one of the plurality of content items 334-4, as illustrated by pull line 350. The pull line 350 is illustrated for purely explanatory purposes. The pull gesture is associated with the finger-wearable device 320 pulling the second one of the plurality of content items 334-4 out of the grid 330. Based on finger manipulation data indicative of the pull gesture, the electronic device 310 converts the second one of the plurality of content items 334-4 from a 2D tile to a 3D cube, and moves the 3D cube out of the grid, as illustrated in FIG. 3P.

In some implementations, the electronic device 310 determines that the pull gesture satisfies a distance threshold, and responsive thereto, removes the second one of the plurality of content items 334-4 from the grid 330. For example, the distance threshold is indicative of a distance that the finger-wearable device 320 pulls the second one of the plurality of content items 334-4 before the electronic device 310 removes the second one of the plurality of content items 334-4 from the grid 330. In some implementations, the electronic device 310 removes the second one of the plurality of content items 334-4 from the grid 330 such that the second one of the plurality of content items 334-4 appears to gravitate towards the finger-wearable device 320 (e.g., once the distance threshold is satisfied).

Although not illustrated, in some implementations, after removing the second one of the plurality of content items 334-4 from the grid 330 and in response to detecting a gesture (e.g., a de-pinch gesture) outside of the grid 330, the electronic device 310 returns the second one of the plurality of content items 334-4 to its previous position within the grid 330. For example, the electronic device 310 returns the second one of the plurality of content items 334-4 to the second row, fourth column position within the grid 330.

As illustrated in FIGS. 3P and 3Q, the finger-wearable device 320 performs a push gesture with respect to the second one of the plurality of content items 334-4, as illustrated by push line 352. The push line 352 is illustrated for purely explanatory purposes. The push gesture is associated with the finger-wearable device 320 pushing the second one of the plurality of content items 334-4 into the fourth row of the grid 330.

As illustrated in FIGS. 3R and 3S, the finger-wearable device 320 performs a de-pinch gesture, as indicated by de-pinch line 354 (illustrated for purely explanatory purposes). Based on finger manipulation data indicative of the push gesture and the de-pinch gesture, the electronic device 310 converts the second one of the plurality of content items 334-4 from the 3D cube back to the 2D tile, and positions the 2D tile corresponding to the ending position associated with the push gesture, as illustrated in FIG. 3S.

FIG. 4 is an example of a flow diagram of a method 400 of changing a dimensional representation of a content item in accordance with some implementations. In various implementations, the method 400 or portions thereof are performed by an electronic device (e.g., the electronic device 100 in FIG. 1 or the electronic device 310 in FIGS. 3A-3S). In various implementations, the method 400 or portions thereof are performed by a head-mountable device (HMD). In some implementations, the method 400 is performed by processing logic, including hardware, firmware, software, or a combination thereof. In some implementations, the method 400 is performed by a processor executing code stored in a non-transitory computer-readable medium (e.g., a memory). In various implementations, some operations in method 400 are, optionally, combined and/or the order of some operations is, optionally, changed.

As represented by block 402, the method 400 includes displaying a plurality of content items. A particular one of the plurality of content items may represent one of a variety of content types, such as audio content, video content, image content, file content, metadata content, database content, and/or the like. In some implementations, the plurality of content items is displayed according to a grid pattern (e.g., the grid 330 in FIG. 3B). In some implementations, the plurality of content items is spatially associated with a physical surface, which is within a viewable region on the display. For example, with reference to FIG. 3B, the electronic device 310 identifies the physical table 302 within image data representing the physical table 302, and generates display data including the grid 330 being substantially orthogonal to the physical table 302. In some implementations, the plurality of content items are arranged according to a stack or a horizontal scroll view.

As represented by block 404, while displaying the plurality of content items, the method 400 includes obtaining finger manipulation data from a finger-wearable device via a communication interface. For example, as described with reference to FIGS. 3A-3S, the electronic device 310 obtains various types of finger manipulation data from the finger-wearable device 320. The finger manipulation data may indicate positional information (e.g., six degrees of freedom) and contact intensity (e.g., pressure) information associated with the finger-wearable device. In some implementations, the finger manipulation data is indicative of a gesture performed by the finger-wearable device. According to various implementations, the finger manipulation data corresponds to sensor data associated with one or more sensors integrated within the finger-wearable device.

For example, as represented by block 406, the sensor data includes positional data output from one or more positional sensors integrated in the finger-wearable device. As one example, the positional data is indicative of a rotational movement (e.g., 3D rotational data) and/or a translational movement (e.g., 3D positional data) of the finger-wearable device. In some implementations, an IMU (e.g., a gyroscope, accelerometer, etc.) that is integrated within the finger-wearable device outputs 3D rotational data. For example, the positional data is indicative of a rotation of the finger-wearable device, such as the pinch gesture and the de-pinch gesture respectively described with reference to FIGS. 3D-3F and FIGS. 3L-3N. In some implementations, a magnetic sensor that is integrated within the finger-wearable device outputs magnetics sensor data that includes 3D positional data. The magnetic sensor may sense weak magnetic fields in order to generate the magnetic sensor data. For example, the positional data is indicative of a movement of the finger-wearable device, such as the pull gesture and the push gestures described with reference to FIGS. 30-3S.

As another example, as represented by block 408, the sensor data includes contact intensity data output from a contact intensity sensor integrated in the finger-wearable device. As one example, the contact intensity data includes interferometer data that is indicative of tap pressure associated with a gesture that is performed by the finger-wearable device. The interferometer data may be from an interferometer that is integrated within the finger-wearable device. For example, the interferometer data indicates a pressure level associated with a finger, which is wearing the finger-wearable device, contacting a physical object. As one example, the finger-wearable device senses (e.g., via the contact intensity sensor) deflection of a pad of a finger when the finger contacts the physical surface. Accordingly, various implementations disclosed herein enable a user to feel a physical surface (and the texture of the physical surface) with which the user is interacting. As another example, with reference to FIG. 3K, the electronic device 310 determines, based on contact intensity data, that the finger, which is wearing the finger-wearable device 320, is contacting the surface of the physical table 302 upon completing movement of the first one of the plurality of content items 338-4.

As yet another example, in some implementations, the sensor data includes a combination of the positional data and the contact intensity data.

As represented by block 410, the method 400 includes selecting (e.g., disambiguating) a first one of the plurality of content items based on a first portion of the finger manipulation data in combination with satisfaction of a proximity threshold. As represented by block 412, the first one of the plurality of content items is associated with a first dimensional representation, such as 2D tile or a 3D object (e.g., a cube or sphere).

In some implementations, as represented by block 414, selecting the first one of the plurality of content items includes determining that the first portion of the finger manipulation data is indicative of a first gesture type. For example, with reference to FIGS. 3D-3F, the electronic device 310 determines, based on the first portion of the finger manipulation data, that the finger-wearable device 320 is indicative of a pinch gesture type. Moreover, the electronic device 310 determines, based on the first portion of the finger manipulation data, that the pinch gesture terminates within the tile 338-4 and thus satisfies the proximity threshold with respect to the tile 338-4. Accordingly, the electronic device 310 selects the tile 338-4, as is illustrated in FIG. 3F.

As represented by block 416, the method 400 includes changing the first one of the plurality of content items from the first dimensional representation to a second dimensional representation based on a second portion of the finger manipulation data. For example, as represented by block 418, changing the first one of the plurality of content items includes changing from a 2D representation to a 3D representation, such as described with reference to FIGS. 3G-3I. As another example, as represented by block 420, changing the first one of the plurality of content items includes changing from a 3D representation to a 2D representation, such as described with reference to FIGS. 3L-3N.

In some implementations, as represented by block 422, changing the first one of the plurality of content items includes determining that the second portion of the finger manipulation data is indicative of a second gesture type. The second gesture type may be different from the first gesture type. In some implementations, the second gesture type corresponds to a pull gesture. For example, with reference to FIGS. 30 and 3P, in response to detecting the pull gesture represented by movement line 350, the electronic device 310 changes the second one of the plurality of content items 333-4 from the 2D tile to the 3D cube. In some implementations, the second gesture type corresponds to a push gesture. In some implementations, the second gesture type corresponds to a combination of a push gesture and a de-pinch gesture. For example, with reference to FIGS. 3P-3S, in response to detecting the push gesture followed by detecting the de-pinch gesture, the electronic device 310 changes the second one of the plurality of content items 333-4 from the 3D cube to the 2D tile.

In some implementations, as represented by block 424, the method 400 includes adding, on the display, an affordance based on the second portion of the finger manipulation data. For example, with reference to FIGS. 3L-3N, in response to detecting a de-pinch gesture proximate to (e.g., within) the control interface 340, the electronic device 310 displays an affordance that is provided to enable user engagement with the first one of the plurality of content items 338-4. In some implementations, the electronic device 310 displays the affordance within the control interface 340. For example, when the first one of the plurality of content items 338-4 corresponds to audio content, the electronic device 310 adds one or more of a playback affordance (e.g., play, pause, stop, fast-forward, rewind) or audio manipulation affordance (e.g., filter, volume control, pitch control) to within the control interface 340. The affordance may be proximate to the first one of the plurality of content items. As another example, the electronic device adds an affordance to within the first one of the plurality of content items.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be implemented in such program instructions, although some or all of the disclosed functions may alternatively be implemented in application-specific circuitry (e.g., ASICs or FPGAs or GP-GPUs) of the computer system. Where the computer system includes multiple computing devices, these devices may be co-located or not co-located. The results of the disclosed methods and tasks may be persistently stored by transforming physical storage devices, such as solid-state memory chips and/or magnetic disks, into a different state.

Various processes defined herein consider the option of obtaining and utilizing a user's personal information. For example, such personal information may be utilized in order to provide an improved privacy screen on an electronic device. However, to the extent such personal information is collected, such information should be obtained with the user's informed consent. As described herein, the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well-established, user-accessible, and recognized as in compliance with or above governmental/industry standards. Moreover, these parties will not distribute, sell, or otherwise share such information outside of any reasonable and legitimate purposes.

Users may, however, limit the degree to which such parties may access or otherwise obtain personal information. For instance, settings or other preferences may be adjusted such that users can decide whether their personal information can be accessed by various entities. Furthermore, while some features defined herein are described in the context of using personal information, various aspects of these features can be implemented without the need to use such information. As an example, if user preferences, account names, and/or location history are gathered, this information can be obscured or otherwise generalized such that the information does not identify the respective user.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various implementations described above can be combined to provide further implementations. Accordingly, the novel methods and systems described herein may be implemented in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A method comprising:
at an electronic device with one or more processors, a non-transitory memory, a display, and a communication interface provided to communicate with a finger-wearable device:
while displaying a plurality of content items on the display, obtaining finger manipulation data from the finger-wearable device via the communication interface;
selecting a first one of the plurality of content items based on a first portion of the finger manipulation data in combination with satisfaction of a proximity threshold, wherein the first one of the plurality of content items is associated with a first dimensional representation; and
changing the first one of the plurality of content items from the first dimensional representation to a second dimensional representation based on a second portion of the finger manipulation data.

2. The method of claim 1, wherein selecting the first one of the plurality of content items includes determining that the first portion of the finger manipulation data is indicative of a first gesture type.

3. The method of claim 2, wherein the first gesture type corresponds to a pinch gesture.

4. The method of claim 1, wherein changing the first one of the plurality of content items from the first dimensional representation to the second dimensional representation includes determining that the second portion of the finger manipulation data is indicative of a second gesture of a second gesture type.

5. The method of claim 4, wherein the second gesture type corresponds to a de-pinch gesture.

6. The method of claim 4, wherein the second gesture type corresponds to a pull gesture.

7. The method of claim 4, wherein the second gesture type corresponds to a push gesture.

8. The method of claim 1, wherein the first dimensional representation corresponds to a two-dimensional (2D) representation of the first one of the plurality of content items, and wherein the second dimensional representation corresponds to a three-dimensional (3D) representation of the first one of the plurality of content items.

9. The method of claim 1, wherein the first dimensional representation corresponds to a three-dimensional (3D) representation of the first one of the plurality of content items, and wherein the second dimensional representation corresponds to a two-dimensional (2D) representation of the first one of the plurality of content items.

10. The method of claim 1, further comprising adding, on the display, an affordance based on the second portion of the finger manipulation data.

11. The method of claim 1, further comprising displaying, on the display, the plurality of content items according to a grid pattern.

12. The method of claim 1, wherein the plurality of content items is spatially associated with a physical surface, and wherein the physical surface is within a viewable region on the display.

13. The method of claim 1, wherein the finger manipulation data corresponds to sensor data associated with one or more sensors integrated within the finger-wearable device.

14. The method of claim 13, wherein the sensor data includes positional data output from one or more positional sensors integrated in the finger-wearable device.

15. The method of claim 13, wherein the sensor data includes contact intensity data output from a contact intensity sensor integrated in the finger-wearable device.

16. The method of claim 1, wherein the electronic device corresponds to a head-mountable device (HMD).

17. An electronic device comprising:
one or more processors;
a non-transitory memory;
a display;
a communication interface provided to communicate with a finger-wearable device; and
one or more programs, wherein the one or more programs are stored in the non-transitory memory and configured to be executed by the one or more processors, the one or more programs including instructions for:
while displaying a plurality of content items on the display, obtaining finger manipulation data from the finger-wearable device via the communication interface;
selecting a first one of the plurality of content items based on a first portion of the finger manipulation data in combination with satisfaction of a proximity threshold, wherein the first one of the plurality of content items is associated with a first dimensional representation; and
changing the first one of the plurality of content items from the first dimensional representation to a second dimensional representation based on a second portion of the finger manipulation data.

18. The electronic device of claim 17, wherein selecting the first one of the plurality of content items includes determining that the first portion of the finger manipulation data is indicative of a first gesture type.

19. The electronic device of claim 17, wherein changing the first one of the plurality of content items from the first dimensional representation to the second dimensional representation includes determining that the second portion of the finger manipulation data is indicative of a second gesture of a second gesture type.

20. A non-transitory computer readable storage medium storing one or more programs, the one or more programs comprising instructions, which, when executed by an electronic device with one or more processors, a display, and a communication interface provided to communicate with a finger-wearable device, cause the electronic device to:
while displaying a plurality of content items on the display, obtain finger manipulation data from the finger-wearable device via the communication interface;
select a first one of the plurality of content items based on a first portion of the finger manipulation data in combination with satisfaction of a proximity threshold, wherein the first one of the plurality of content items is associated with a first dimensional representation; and
change the first one of the plurality of content items from the first dimensional representation to a second dimensional representation based on a second portion of the finger manipulation data.
